(19) United States
(12) Patent Application Publication
(10) Pub. No.: US 2025/0149271 A1
(43) Pub. Date: May 8, 2025

(54) ACCESS CONTROL DEVICE AND HOUSING

(71) Applicant: SISTECH PRODUCTS SG PTE. LTD., Singapore (SG)

(72) Inventors: Peter HARRIS, Seven Hills (AU); Wayne PATERSON, Regentville (AU); Robbie WELLS, Surry Hills (AU); Sebastian DAVIES, Surry Hills (AU); Mark IRWIN, Surry Hills (AU)

(21) Appl. No.: 18/933,417

(22) Filed: Oct. 31, 2024

(30) Foreign Application Priority Data
Nov. 3, 2023 (AU) 2023903529

(51) Int. Cl. H01H 13/70; G07C 9/00

(52) U.S. Cl. CPC H01H 13/70; G07C 9/00817

(57) ABSTRACT

An access control housing for an access control user interface, the housing including a key interface seat having a key module connector and a key module receiving frame, wherein the key module connector includes a power connection for providing power to a key module, and a data connection for providing key module data to a main controller, wherein the key module receiving frame is adapted to removably receive a key module selected from a group of different key modules. The different key modules may have different sizes and the key module receiving frame may be interchangeable or resizable so that the key interface seat is adapted to hold key modules of different sizes.

### CROSS-REFERENCE TO RELATED APPLICATIONS

The present application claims priority from Australian Provisional Patent Application No 2023903529 filed on 3 Nov. 2023, the contents of which are incorporated herein by reference.

### TECHNICAL FIELD

The present disclosure broadly relates to access controllers and, more particularly, to an access control device housing for a controller that locks and unlocks a door lock.

### BACKGROUND

Typical access control systems, for example the type of system used for data centre access control, include several functional parts such as a card reader or keypad for user identification and authentication, some kind of user interface, a power supply interface, etc. The more functionality included in the system, the more functional modules need to be interconnected, and this results in a complex system to install. Installation of multi-functional access control systems can be complicated and time consuming because of the wiring required to connect all the modules within the system, and on location.

FIGS. 16A and 16B of the drawings show an example of a prior art access control panel that includes a red and green light used to show a user whether access to a door is allowed and/or obtained, a keypad, and an emergency access button. Each of these four components are separate components provided in an access control device housing.

In other examples, prior art access control panels include, for example, five lights used to communicate access control information to a user, a card reader, and an emergency access button.

Not only are these prior art access control systems bulky, they are also time-consuming to install because each component must be installed separately and then the various components are interconnected.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In one aspect there is provided an access control housing for an access control user interface, the housing comprising: a key interface seat having a key module connector and a key module receiving frame, wherein the key module connector comprises a power connection for providing power to a key module, and a data connection for providing key module data to a main controller, wherein the key module receiving frame is adapted to removably receive a key module selected from a group of different key modules.

The different key modules may have different sizes, and the key module receiving frame may be interchangeable so that the key interface seat is adapted to hold key modules of different sizes. Additionally or alternatively, the key module receiving frame may be resizable so that the key interface seat is adapted to hold key modules of different sizes.

Throughout this specification the word “comprise” or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1A is a schematic representation of an embodiment of an access controller.

FIG. 1B is a schematic representation of an access control system.

FIG. 2A is a side view of an embodiment of an access controller.

FIG. 2B is a front view of the access controller of FIG. 2A.

FIG. 2C is a side view of another embodiment of an access controller.

FIG. 2D is a front perspective view of the access controller of FIG. 2C.

FIG. 3A is a front perspective view of another embodiment of an access controller.

FIG. 3B is a front view of the access controller of FIG. 3A.

FIG. 3C is a back perspective view of the access controller of FIGS. 3A and 3B.

FIG. 4 is an exploded view of another embodiment of an access controller.

FIG. 5A is a first embodiment of a key module.

FIG. 5B is a second embodiment of a key module.

FIG. 5C is a third embodiment of a key module.

FIG. 5D is a fourth embodiment of a key module.

FIG. 5E is a fifth embodiment of a key module.

FIG. 6A is a side view of another embodiment of an access controller.

FIG. 6B is a front view of the access controller of FIG. 6A.

FIG. 6C is a side view of another embodiment of an access controller.

FIG. 6D is a front perspective view of another embodiment of an access controller.

FIG. 7 is a front perspective view of another embodiment of an access controller.

FIG. 8 is an exploded view of another embodiment of an access controller.

FIG. 9 shows the inside of another embodiment of an access controller.

FIG. 10A is a schematic representation of the operation of an access controller in a first operating condition.

FIG. 10B is a schematic representation of the operation of the access controller of FIG. 10A in a second operating condition.

FIG. 10C is a schematic representation of the operation of the access controller of FIG. 10A in a third operating condition.

FIG. 10D is a schematic representation of the access controller of FIG. 10A in a fourth operating condition.

FIG. 11 is a schematic representation of the access controller of FIG. 10A in a fifth operating condition.

FIG. 12 is a schematic representation of the access controller of FIG. 10A in a sixth operating condition.

FIGS. 13A and 13B show a first embodiment of a reader insert.

FIGS. 14A and 14B show a second embodiment of a reader insert.

FIGS. 15A and 15B show a third embodiment of a reader insert.

FIG. 16A is a front view of a prior art access system.

FIG. 16B is a side view of the prior art access system of FIG. 16A.

In the drawings, like reference numerals designate similar parts.

### DETAILED DESCRIPTION

Access control for a building or room that requires controlled access, for example Data Centre access control, requires an access controller that is able to take various factors into consideration before locking or unlocking a lock to allow or block access to the building or room. Described herein is a control unit that houses a key module (e.g., a card reader) to allow authorised users into controlled spaces, a user interface (e.g., an LED light indicator and/or a tone sounder), and optionally an emergency door release and/or a tamper switch that detects if the access controller is removed from the wall and/or its housing is opened.

In prior art systems such modules were comprised of segregated components. Consequently, the separate and individual components required extensive installation time and skills to provide the level of security required by the access control system.

The access controller described herein simplifies the installation process by combining all security features within one unit that can be installed in less than 10 minutes by an engineer or technician.

This is beneficial, for example in large data centres where access control must be provided as part of projects with tight lead times before the centres are to be operational. The access controller described herein advantageously simplifies installation and testing for access control installation.

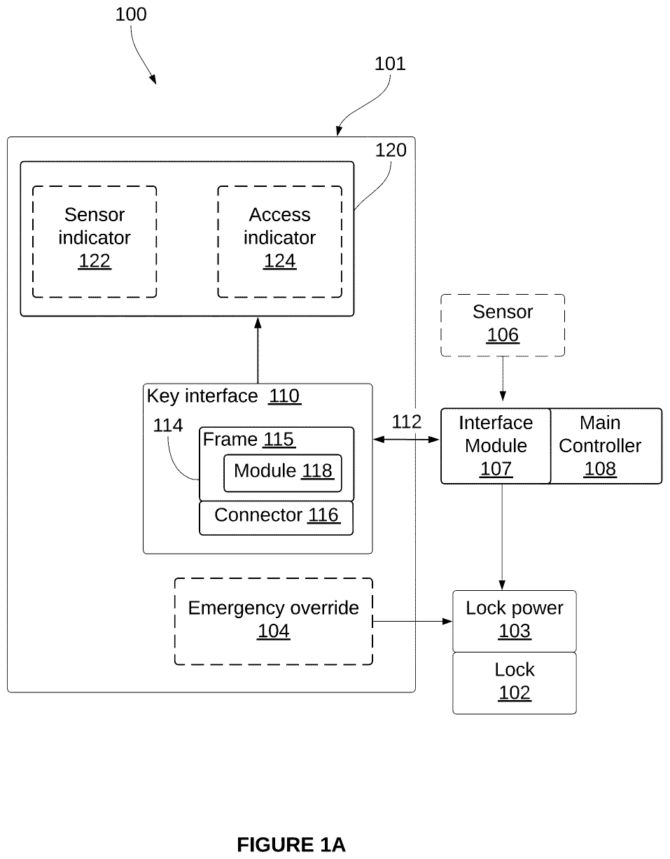

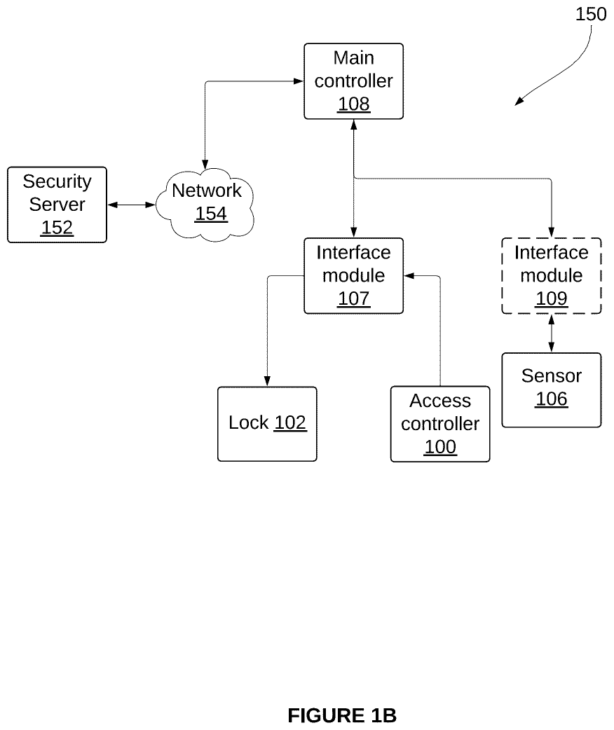

FIG. 1A of the drawings is a diagrammatic representation of an access controller 100 for controlling a lock 102. The access controller has a key interface 110 configured to receive a key input, and responsive to the key input provide a key signal 112 to a main controller 108, via an interface module 107. The key interface 110 comprises a key interface seat 114 configured to receive a removable and/or interchangeable key module 118. Optionally, the access controller may include tamper switch (not shown) and/or an emergency override module 104 (e.g. an emergency door release) configured to receive an override input, and responsive to the override input cause the lock 102 to lock or unlock as required.

In some exemplary embodiments, the lock 102 is locked and/or unlocked by connecting and/or disconnecting (or vice versa) the lock power supply 103. In these embodiments, the main controller 108 opens/closes the via an interface module 107 that is configured to control the power supply to the lock. For this, the interface module 107 has a suitable electrical or electronic switching mechanism, for example a relay, one or more transistors (e.g. a MOSFET), etc.

The access controller may include an indicator 120 configured to output access information to a user. The indicator 120 may comprise an access indicator 124 configured to receive access information from the key interface 110 and/or form the main controller 108 via the key interface 110.

In embodiments where the access control system includes a sensor 106, the indicator 120 may comprise a sensor indicator 122 configured to display a sensor indication responsive to received sensor information from a sensor 106.

In some embodiments, custom designed LED light indicators provide visual alerts of access control information, reducing cost and adding additional functionality that will allow lights to function based on multiple elements such as access granted/denied, door status and override activation. In some embodiments, the lights system works alongside a sound indicator, for example a seven-tone sounder. In other embodiments other types of user interfaces may be used, such as a display screen, a touch screen, or a seven-segment display.

Referring to FIG. 1B of the drawings, an embodiment of an access control system 150 is shown. The access controller 100 is in communication with the main controller 108 via an interface module 107 which, in turn, is configured to control the lock 102 by locking and/or unlocking it (e.g. by connecting and/or disconnecting the power supplied to the lock 102). The main controller 108 is in communication with a security server 152 via a communication network 154. Optionally, in embodiments that include a sensor 106, the sensor 106 is in communication with the main controller 108 (in some embodiments this may be via a sensor interface module 109).

The sensor 106 may be a sensor to determine whether a door can be opened or not; for example, a motion sensor or camera may be used to determine whether something is blocking the door or is being accessed from the other side. If the door is blocked and cannot be opened, then the sensor indicator will display an indication to a user to show that the door cannot be opened. Data communication between the various components, for example between the access controller 100 and the main controller 108, may be via a wired or wireless communication network using wired or wireless protocols such as Ethernet or Wi-Fi.

The key interface is in communication with a main controller 108 in order to determine the key signal based on the key input. For example, where the key module is a card reader, the reader is in communication with the main controller, which in turn may be in data communication with a server 152 having a database of users with information about access entitlements. The server then provides the main controller with information regarding access granted or denied for the specific user associated with the identified card. The main controller 108 then instructs the interface module 107 to lock or unlock the lock 102 of the door.

Referring again to FIG. 1A of the drawings, the access controller 100 has a unique access control device housing 101 adapted to hold and combine the various functional parts of the access controller 100, and supports the use of a variety of key modules by providing a key interface seat 114 that can receive one or more of various types of key modules.

In one embodiment, the access control housing 101 for an access control user interface comprises a key interface seat 114 that has a key module connector 116 and a key module receiving frame 115.

The key module connector 116 comprises a power connection for providing power to the key module 118, and a data connection for providing key module data to the main controller 108 (in some embodiments via an interface module 107 to the main controller 108).

The key module receiving frame 115 is adapted to removably receive a key module 118 selected from a group of different key modules. The different key modules may have different sizes, and the key module receiving frame can be interchangeable and/or resizable so that the key interface seat 114 is adapted to hold key modules of different sizes.

The key module may include one or more of: a keypad, a card reader, a key switch, a radio frequency reader, a near field communication reader, a biometric scanner, a code scanner, a smart card scanner and a Bluetooth receiver. For example, in some embodiments, the key interface seat may be in the form of a reader adapter allowing the housing to work with different card readers, such as the 3millID (S-Gang and Keypad), HID (RK40 and R40) and Safetrust card readers.

In embodiments where more than one key module is received into the housing of the access controller, more than one key module connector and receiving frame is provided in the housing.

The key interface seat 114 of the housing 101 is configured to be adaptable in order to removably receive a key module. Typically the key module body is held in place by the receiving frame of the key interface seat, and the key module is operatively connected (via the connector 116) to the main controller 108, typically via an interface module 107.

Additionally or alternatively, in some embodiments, a first key module may be interchangeably received in the key interface seat 114, so that upon removal, a second key module may be received and held by the seat. The first key module and the second key module may be the same or may be different. The first key module and the second key module may have the same or different dimensions.

The key module connector(s) 116 may include one or more of: electrical connectors, cable harnesses, cable assemblies, and/or wiring looms.

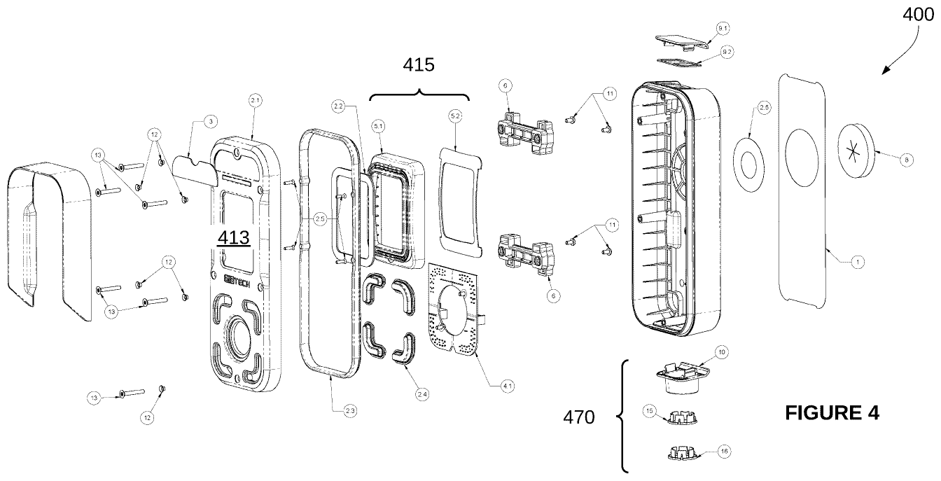

Referring to the embodiment of an access controller 400 illustrated in FIG. 4 of the drawings, the receiving frame 413 includes a key module adaptor 415 that comprises a reader insert and a reader gasket, both sized to match a selected key module.

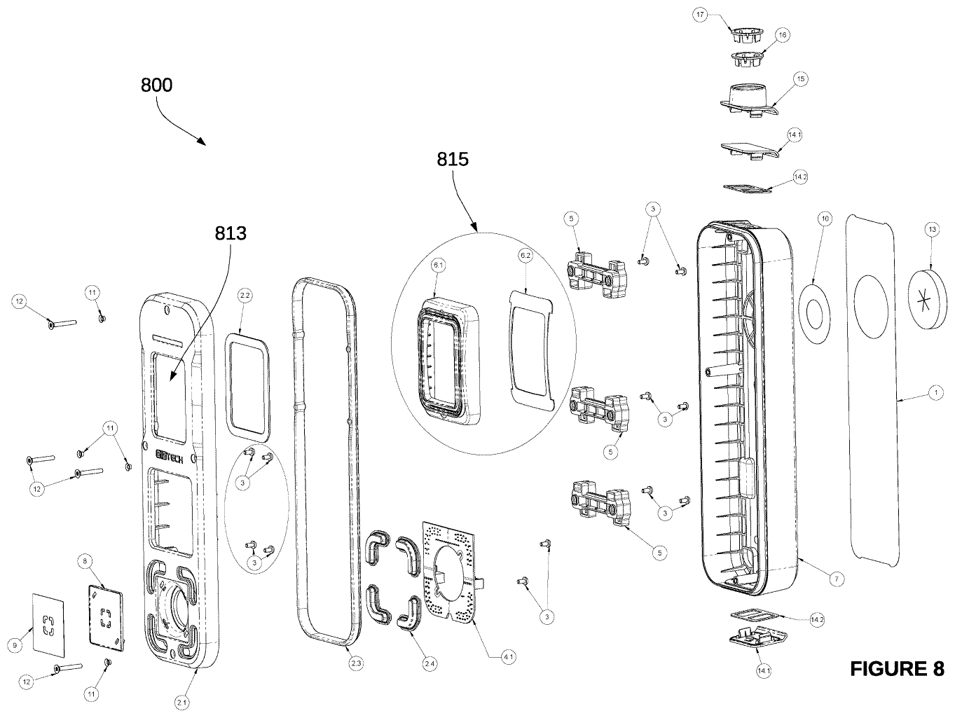

Referring to the embodiment of an access controller 800 illustrated in FIG. 8 of the drawings, the receiving frame 813 includes a key module adaptor 815 that comprises a reader insert and a reader gasket, both sized to match a selected key module.

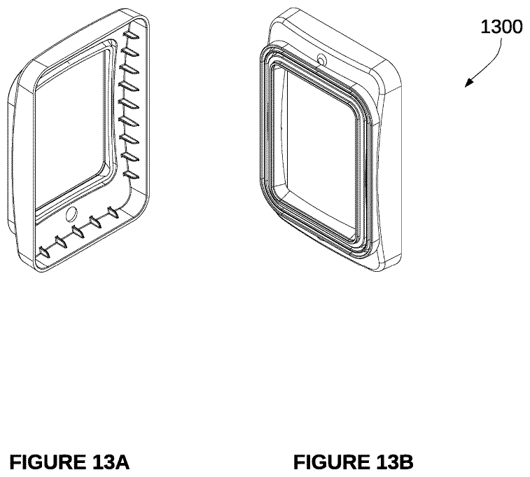

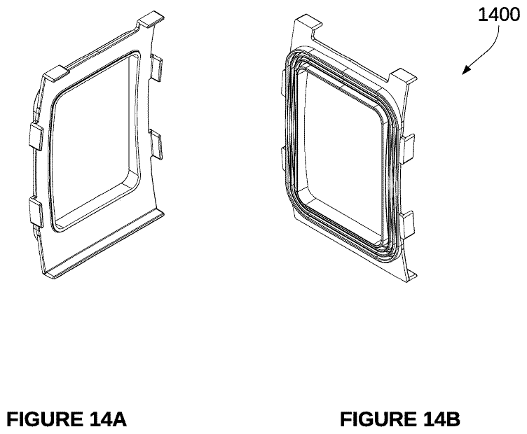

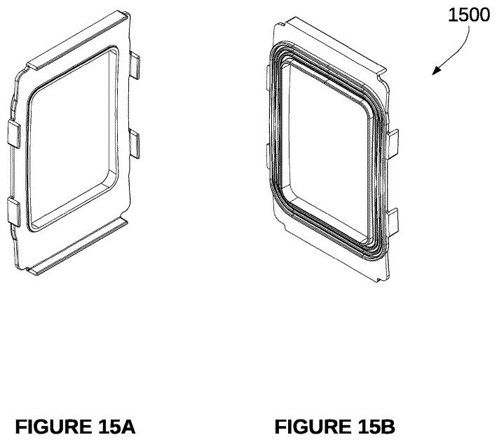

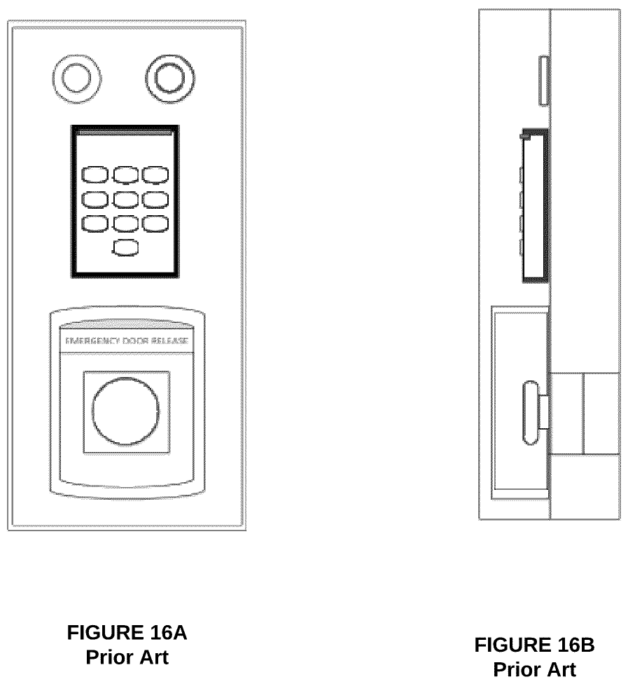

FIGS. 13A and 13B show a first embodiment of a reader insert, sized and shaped to hold a 3Mill type reader. FIGS. 14A and 14B show a second embodiment of a reader insert, sized and shaped to hold an HID type reader. FIGS. 15A and 15B show a third embodiment of a reader insert, sized and shaped to hold a Safetrust type reader. All three of these reader inserts are compatible with, and interchangeable within the housing embodiments illustrated in FIGS. 4 and 8. Each insert includes a front face comprising a window that allows access to the key module held in place by the insert, the front face having a circumferential rim for holding the key module. Each insert also has at least two opposing side walls for retaining the key module within the housing; in some embodiments these form part of one continuous circumferential side wall.

In alternative embodiments, the key module adaptor may comprise a resilient frame, resizable to hold various sizes of key modules. For example, the resilient frame may comprise a flexible rubber holding rim, and/or one or more retractable holding frame members biased inward to hold the body of a key module inserted into the key frame.

### Example Embodiments

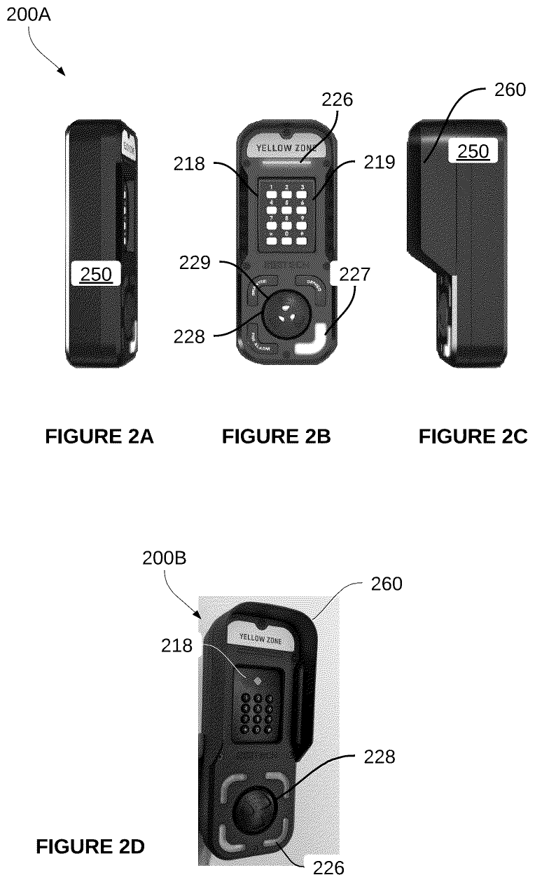

FIGS. 2A and 2B show an embodiment of an access controller 200A. The housing 250 includes both visual indicators 226 in the form of various light segments 227, and an audio indicator 228 in the form of a speaker 229. The key module 218 in this example is in the form of a key pad 219.

FIGS. 2C and 2D show another embodiment of an access controller 200B. Similar to the access controller 200A shown in FIGS. 2A and 2B, access controller 200B has a housing 250 that includes both visual indicators 226 and an audio indicator 228. In this embodiment the housing includes a projecting rim 260 or flange (similar to an eave) around at least part of the access controller 200B, for example halfway up the sides and over the top. This is useful to protect the user interface (for example the key module), for example from the elements, such as rain, when the access controller 200B is mounted outside.

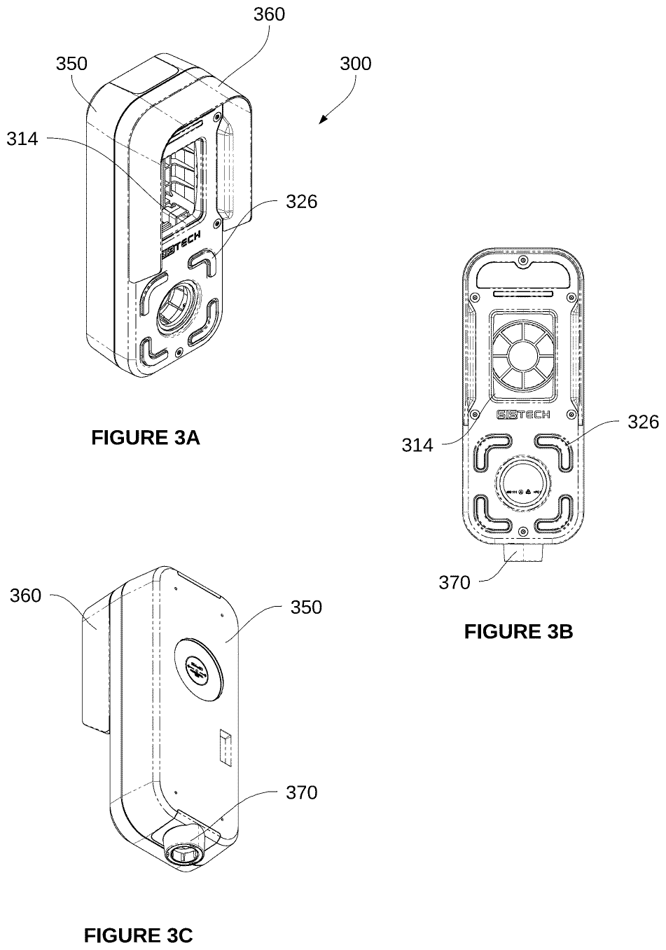

FIGS. 3A-3C show another embodiment of an access controller 300. The housing 350 includes a projecting rim 360, and both visual indicators 326 and an audio indicator are provided (in the figures, the speaker has not been placed into the housing yet, and a receiving seat for the speaker can be seen). A cable conduit 370 is provided on the underside of the access controller 300. In other embodiments the cable conduit may be provided on one or more of any of the sides of the access controller.

FIG. 4 is an exploded view of another embodiment of an access controller 400. Components are described in Table 1:

TABLE 1
FIG. 4 Access Controller components

| Item | | |
|---|---|---|
| No. | Part Name | Qty |
| 1 | Wall Sticker | 1 |
| 2 | Front Shell Assembly | 1 |
| 2.1 | Front Shell | 1 |
| 2.2 | Reader Common Gasket | 1 |
| 2.3 | Shell Seal | 1 |
| 2.4 | Light Pipe | 4 |
| 2.5 | M3 × 12 Phillips Head CSK Screw Stainless Steel | 4 |
| 2.5 | Wall Gasket Sticker | 1 |
| 2.6 | Shroud | 1 |
| 2.7 | Light Pipe Infill | 1 |
| 3 | Zone Decal | 1 |
| 4 | Main PCB | 1 |
| 5 | Reader Insert Sub assembly | 1 |
| 5.1 | Reader Insert | 1 |
| 5.2 | Reader Gasket | 1 |
| 6 | Bracket, Internal Mount | 2 |
| 8 | Wall Gasket | 1 |
| 9 | Conduit Infill Sub Assembly | 1 |
| 9.1 | Conduit Infill | 1 |
| 9.2 | Conduit Gasket | 1 |
| 10 | Conduit Insert | 1 |
| 11 | M4 × 8 Philips Pan Head Screw | 6 |
| 12 | M4 Nyltite Washer | 6 |
| 13 | M4 × 30 Tamper-Resistant Torx Screw | 6 |
| 14 | Rear Shell | 1 |
| 15 | 25 mm EMT Collar | 1 |
| 16 | 3/4 inch EMT Collar | 1 |

The key interface seat is provided by the insert sub-assembly, including the gasket and brackets. The key interface seat is configured to receive a key module.

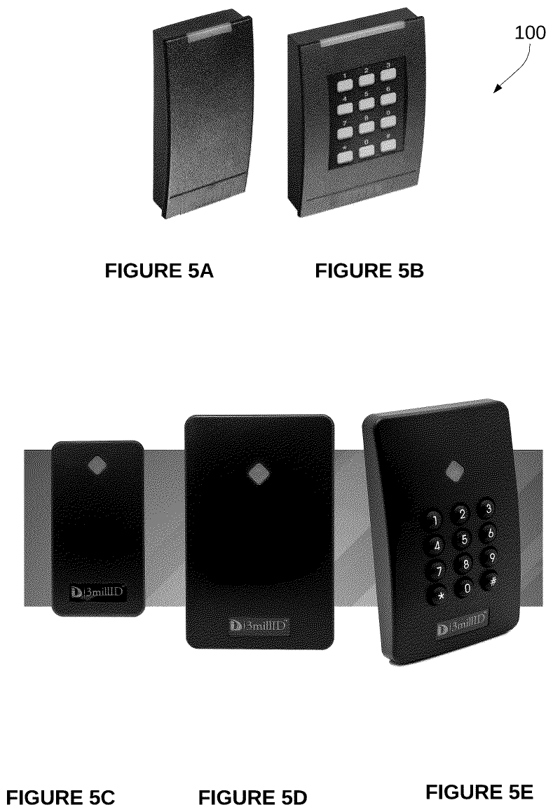

FIG. 5A is a first example embodiment of a key module in the form of a card reader. FIG. 5B is a second example embodiment of a key module in the form of a key pad. FIG. 5C is a third example embodiment of a key module in the form of a tag reader. FIG. 5D is a fourth example embodiment of a key module in the form of another card reader. FIG. 5E is a fifth example embodiment of a key module in the form of a keypad. These key modules are all examples that can be received into the access controller housing illustrated in FIG. 4.

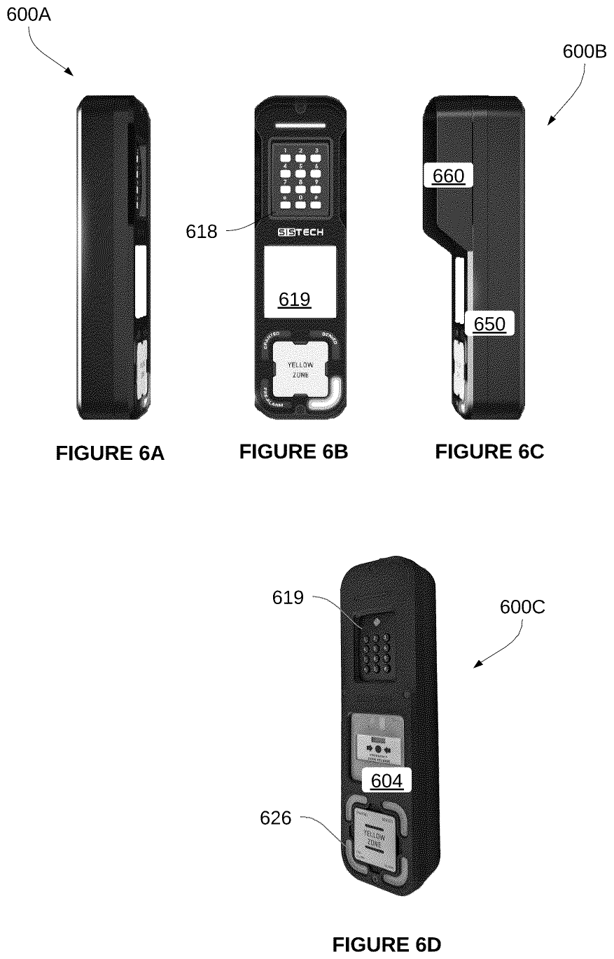

FIGS. 6A and 6B show another embodiment of an access controller 600A that includes a keypad as the key module 618, and also includes an event data recorder (EDR) 619.

FIG. 6C shows another embodiment of an access controller 600B, similar to the access controller 600A in FIGS. 6A and 6B. The housing 650 of access controller 600B includes a projecting rim 660.

FIG. 6D shows another embodiment of an access controller 600C that includes a keypad 619, an emergency override module 604, and a four-light indicator 626.

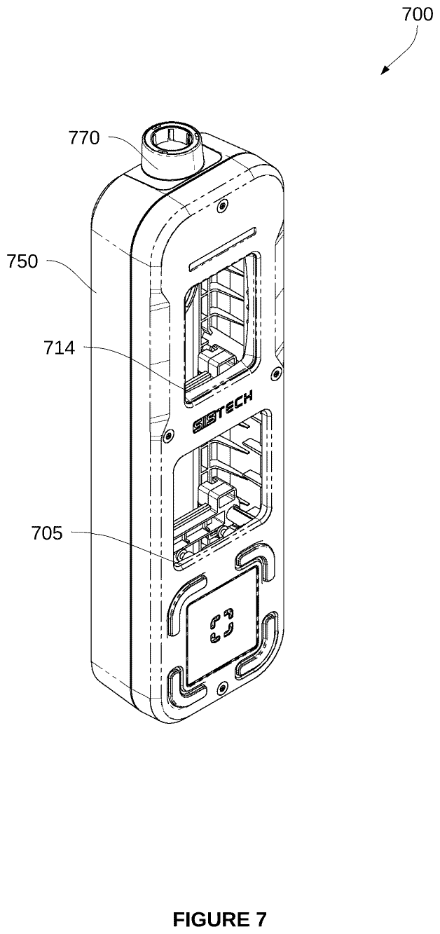

FIG. 7 shows another embodiment of an access controller 700. The housing 750 includes a key seat 714 as well as a seat 705 for an emergency override (not shown). A cable conduit 770 is provided at the top of this embodiment. In alternative embodiments the conduit may be provided in another position, such as the front, back, sides etc. of the housing. For example, as illustrated in FIG. 4, the conduit 470 is provided at the bottom of the controller 400.

FIG. 8 is an exploded view of another embodiment of an access controller 800. Components are described in Table 2:

TABLE 2
FIG. 8 Access Controller components

| Item | | |
|---|---|---|
| No. | Part Name | Qty |
| 1 | Wall Sticker | 1 |
| 2 | Front Shell Assembly | 1 |
| 2.1 | Front Shell | 1 |
| 2.2 | Reader Common Gasket | 1 |
| 2.3 | Shell Seal | 1 |
| 2.4 | Light Pipe | 4 |
| 3 | M4 × 8 Philips Pan Head Screw | 12 |
| 4 | Main PCB | 1 |
| 5 | Bracket, Internal Mount | 3 |
| 6 | Reader Insert Sub Assembly | 1 |
| 6.1 | Reader Insert | 1 |
| 6.2 | Reader Gasket | 1 |
| 7 | Rear Shell | 1 |
| 8 | Bell Cover | 1 |
| 9 | Zone Decal | 1 |
| 10 | Wall Gasket Sticker | 1 |
| 11 | M4 Nyltite Collar | 4 |
| 12 | M4 × 30 Tamper-Resistant Torx Screw | 4 |
| 13 | Wall Gasket | 1 |
| 14 | Conduit Infill Sub ASM | 1 |
| 14.1 | Conduit Infill | 1 |
| 14.2 | Conduit Gasket | 1 |
| 15 | Conduit Insert | 1 |
| 16 | 25 mm EMT Collar | 1 |
| 17 | 3/4 inch EMT Collar | 1 |

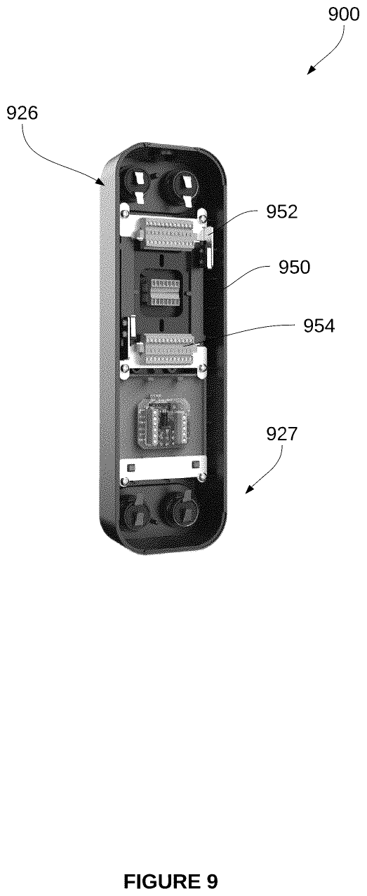

FIG. 9 shows the inside of another embodiment of an access controller 900. The two connectors at the top 926 and the two connectors 927 at the bottom are for Floyd Bell lights (not shown). Other components include a polycarbonate housing 950, steel internal mounting brackets 952, steel powder coated wall mount bracket (not shown), Phoenix contact connectors 954, Omron tamper switches (not shown), GRISK resistors (not shown), and custom wire looms

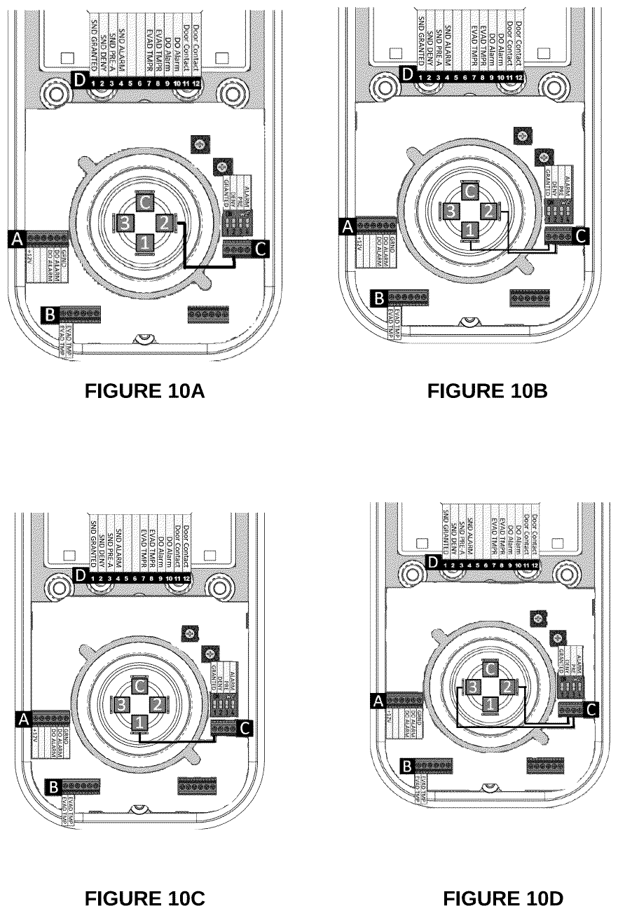

FIG. 10A illustrates the operation of an access controller when access is granted. If an authorised cardholder provides a key input (for example by tapping an access card) and access is granted, then the key module (for example a Lenel panel) will activate its lock relay to unlock the door lock. The access controller provides security as a lock mechanism to controlled areas, meaning only those with authorised access (e.g., via programmed badges) are able to unlock the controlled door. In some embodiments the access controller provides security measures through recorded data of badge logs.

As shown in FIG. 10A, the lock cable will activate Terminal Block D, Input 1. Terminal Block B, Output 2 will send 12 VDC to Sounder Blade 2 until Terminal Block D, Input 1 is no longer active. For the visual indicator, the following Green LEDs are active and solid. The dedicated DIP switch will disable the sounder action but the LED will continue to operate. Some embodiments may include a potentiometer dial that reduces the volume of the sounder from between 110 dB and 55 dB. This is summarised in Table 3:

TABLE 3
Access granted

| Transmitting | | Access control | | | |
|---|---|---|---|---|---|
| Device | | lock relay | | | |
| Input | D1 | Normal State | 0 VDC | Active State | 12 VDC |
| Output | B2 | Output Signal | 12 VDC | Duration | Whilst is |
| | | | | | input active, |
| | | | | | approx . . . |
| | | | | | 3 seconds |
| | | Sounder | | | |

| LED Action | | Action | | Dedicated DIP Switch |
|---|---|---|---|---|
| GREEN | Solid | Blade 1 | | 1: Disables sounder |
| RED | | Blade 2 | X | Potentiometer Dial |
| YELLOW | | Blade 3 | | Modifies the volume |
| BLUE | | | | of the sounder during |
| WHITE | | | | this function. |

FIG. 10B illustrates the operation of the access controller when access is denied. If an unauthorised user provides an input to the key module (for example an unauthorised cardholder presents their card) then access is denied. The key module activates an auxiliary relay to activate Terminal Block D, Input 2. Terminal Block C, Outputs 1 and 2 will send 12 VDC to Sounder Blades 1 and 2 until Terminal Block D, Input 2 is no longer active. The red LEDs are active and solid. The dedicated DIP switch will disable the sounder action but the LED will continue to operate. Some embodiments may include a potentiometer dial that reduces the volume of the sounder from between 110 dB and 55 dB. This is summarised in Table 4:

TABLE 4
Access denied

| Transmitting | | Access control | | | |
|---|---|---|---|---|---|
| Device | | auxiliary relay | | | |
| Input | D2 | Normal State | 0 VDC | Active State | 12 VDC |
| Output | C1 + C2 | Output Signal | 12 VDC | Duration | Input |
| | | | | | active, |
| | | | | | approx . . . |
| | | | | | 3 seconds |
| | | Sounder | | | |
| LED Action | | Action | | Dedicated DIP Switch | |
| GREEN | | Blade 1 | X | 2: Disables sounder | |
| RED | Solid | Blade 2 | X | Potentiometer Dial | |
| YELLOW | | Blade 3 | | Modifies the volume of the | |
| BLUE | | | | sounder during this function. | |
| WHITE | | | | | |

FIG. 10C illustrates the operation of the access controller when the door appears to be held open for too long. If the access control door is opened using an authorised badge and/or PIN, and upon being held open for a first period of time that appears to be too long (for example more than five seconds, e.g., seven to ten seconds), the key module then activates an auxiliary relay to activate Terminal Block D, Input 3. Terminal Block C, Output 1 will send 12 VDC to Sounder Blade 1 until Terminal Block D, Input 3 is no longer active. The yellow LEDs are active and solid. The dedicated DIP switch will disable the sounder action but the LED will continue to operate. This is summarised in Table 5:

TABLE 5
Pre-Alarm

| Transmitting | | Access control | | | |
|---|---|---|---|---|---|
| Device | | auxiliary relay | | | |
| Input | D3 | Normal State | 0 VDC | Active State | 12 VDC |
| Output | C1 | Output Signal | 12 VDC | Duration | Input active, |
| | | | | | Up to 53 |
| | | | | | seconds |
| | | Sounder | | | |
| LED Action | | Action | | Dedicated DIP Switch | |
| GREEN | | Blade 1 | X | 3: Disables sounder | |
| RED | | Blade 2 | | Potentiometer Dial | |
| YELLOW | Solid | Blade 3 | | N/A | |
| BLUE | | | | | |
| WHITE | | | | | |

FIG. 10D illustrates the operation of the access controller when the door is open for too long. When the access control door is left open 60 seconds (DOOR HELD), the access control door is opened without using an authorised badge (DOOR FORCED), the key override input on the key module is activated, the emergency door input on the key module is activated, or the tamper input is activated, then the key module activates an auxiliary relay to activate Terminal Block D, Input 4. Terminal Block C, Outputs 2 and 3 will send 12 VDC to Sounder Blades 2 and 3 until Terminal Block D, Input 4 is no longer active. The blue LEDs are active and solid. The dedicated DIP switch will disable the sounder action but the LED will continue to operate. This is summarised in Table 6:

TABLE 6
Alarm

| Transmitting | | Access control | | | |
|---|---|---|---|---|---|
| Device | | auxiliary relay | | | |
| Input | D4 | Normal State | 0 VDC | Active State | 12 VDC |
| Output | C2 + C3 | Output Signal | 12 VDC | Duration | Input active, |
| | | | | | 1 second to |
| | | | | | indefinitely |
| | | Sounder | | | |
| LED Action | | Action | | Dedicated DIP Switch | |
| GREEN | | Blade 1 | | 4: Disables sounder | |
| RED | | Blade 2 | X | Potentiometer Dial | |
| YELLOW | | Blade 3 | X | N/A | |
| BLUE | Solid | | | | |
| WHITE | | | | | |

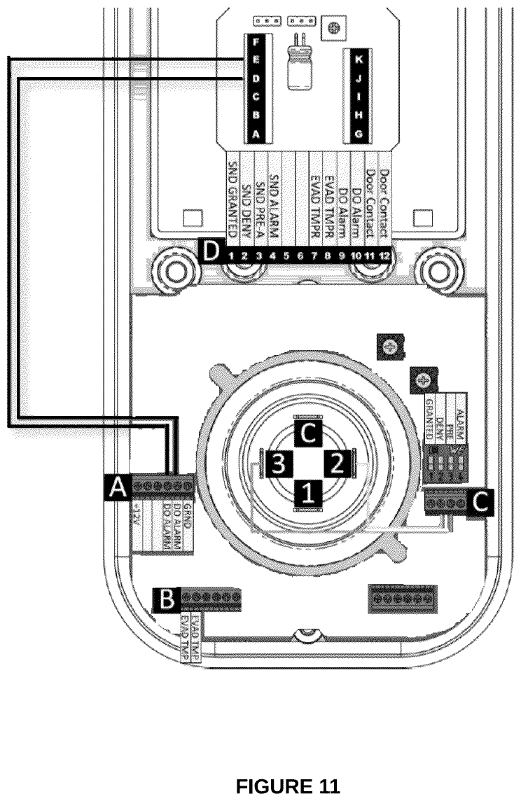

FIG. 11 illustrates the operation of the access controller when the emergency door override is activated. If the door override device (key switch or EDR) is activated then the output from the door override device activates Terminal Block A, DO Alarm. Terminal Block C, Outputs 2 and 3 will send 12 VDC to Sounder Blades 2 and 3 until Terminal Block D, Do Alarm is no longer active. The blue LEDs are active and solid, and the green, red and yellow LEDs are active and flashing. The shared DIP switch will disable the sounder and solid LED (blue) for this function. The sounder and blue LED will still be enabled for other functions. When Terminal Block A, ‘DO Alarm’ is inactive, then Terminal Block D, Outputs 9 and 10 emit 1K (2 closed loop (normal state) to the key module, and when Terminal Block A, ‘DO Alarm’ is active, then Terminal Block D, Outputs 9 and 10 emit 2K Ω open loop to the key module (for example, a Lenel panel). This is summarised in Table 7:

TABLE 7
Door Override

| Transmitting | | Key switch or emergency door release | | | |
|---|---|---|---|---|---|
| Device | | device. | | | |
| Input | A-DO | Normal State | Closed | Active State | Open |
| | Alarm | | | | |
| Output | C2 + C3 | Output Signal | 12 VDC | Duration | Input active, |
| | D9 + D10 | | NC 1K | | 1 second to |
| | | | Ω NO | | indefinitely |
| | | | 2K Ω | | |
| | | Sounder | | | |
| LED Action | | Action | | Shared DIP Switch | |
| GREEN | Flash | Blade 1 | | 5: Disables the sounder and Blue | |
| RED | Flash | Blade 2 | X | LED for this function. | |
| YELLOW | Flash | Blade 3 | X | Potentiometer Dial | |
| BLUE | Solid | | | N/A | |
| WHITE | | | | | |

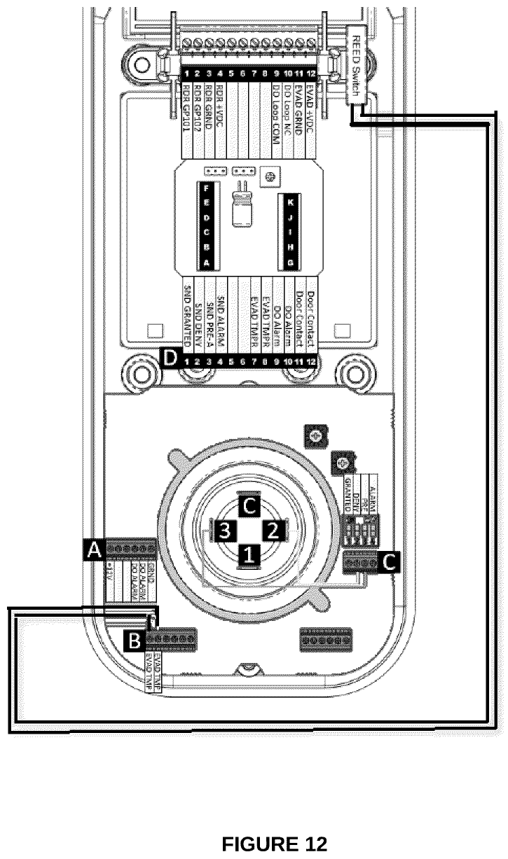

FIG. 12 illustrates the operation of the access controller when tampering with the access controller is detected. If the internal reed tamper switch is activated, then Terminal Block B, EVAD TMP is activated. Terminal Block C, Outputs 2 and 3 will send 12 VDC to Sounder Blades 2 and 3 until Terminal Block B, EVAD TMP is no longer active. The blue LEDs are active and solid. The shared DIP switch will disable the sounder and solid LED (blue) for this function. The sounder and blue LED will still be enabled for other functions. When Terminal Block B, EVAD TMP is inactive, then Terminal Block D Outputs 7 and 8 emit 1K (closed loop (normal state) to the key module, and when Terminal Block B, EVAD TMP is active, then Terminal Block D, Outputs 7 and 8 emit 2K (open loop to the key module. This is summarised in Table 8:

TABLE 8
Tamper detected

| Transmitting | | internal reed switch | | | |
|---|---|---|---|---|---|
| Device | | | | | |
| Input | B-Tamper | Normal State | Closed | Active State | Open |
| Output | C2 + C3 | Output Signal | 12 VDC | Duration | Input active, |
| | D7 + D8 | | NC 1K | | 1 second to |
| | | | Ω NO | | indefinitely |
| | | | 2K Ω | | |
| | | Sounder | | | |
| LED Action | | Action | | Shared DIP Switch | |
| GREEN | | Blade 1 | | 5: Disables the sounder and Blue | |
| RED | | Blade 2 | X | LED for this function. | |
| YELLOW | | Blade 3 | X | Potentiometer Dial | |
| BLUE | Solid | | | N/A | |
| WHITE | | | | | |

### Advantages

Advantageously, the access controller may include a tamper switch that detects if the access controller is removed from the wall and/or the front panel of the device is removed.

The access controller meets required health and safety guidelines providing an emergency exit function accessible from the inside of any room controlled by an access controller.

The access controller provides a housing for a several security products including and not limited to, card reader, key switch, emergency door release.

By combining all the engineering requirements of access control within the access controller, the idea is to limit installation time and minimise risk areas within access security. Prior art access control systems consisted of separate components and the installer had to connect, terminate and install each component separately onsite at the door location. In contrast, the access control device housing described herein makes it possible to supply an access controller fully assembled and pre-wired, so that the installer only has to connect the field cabling to two terminal strips (and screw the assembly to the wall).

In prior art systems, the housing was delivered to site as an empty metal box. All components were fitted into the housing on location, usually at the time of installation. The field wiring, run from the key module (e.g. a Lenel access control panel), would be pulled to the housing and connected directly to each separate device fitted in the housing. In contrast, the access control device housing described herein makes it possible to deliver to site a preassembled and prewired access control system with all wiring terminated to devices on one end and terminal plugs at the other. This may be understood with reference to FIG. 9 which illustrates a preassembled access controller with terminal strips, but not yet prewired. For this example embodiment, at the time of installation, the field wiring is terminated to two female terminal plugs and connected to the male terminal strips on the housing. The next step is to screw the housing to the wall, so that installation is significantly simplified.

The access controller described herein sees the removal of Floyd Bell lights and replacing them with unique custom designed light addition, reducing cost and adding additional functionality that will allow lights to function based on multiple elements of entry/access not just yes/no access granted.

The access controller described herein solves problems associated with existing similar controllers by providing a multi-card reader housing and flexible light indicator functionality.

Advantageously, the access controller described herein reduces installation time, reduces testing errors, is built to work with multiple card readers and sizes, enabling growth within a company and changing of card reader without changing the entire access control unit.

Because they consisted of separate components, prior art controllers could only have full testing onsite after installation. For example, some prior art access controllers contained three mechanical tamper switches which required each component, reader, and EDR to be removed from the housing and tested onsite. In contrast, the access control device housing described herein supports a key module (e.g. a card reader), and optionally also an EDR or other features, being enclosed within the housing. As a result, no tamper switches are required for these components, thus reducing test time.

The access control device housing described herein may also include a magnetic tamper switch which is a sealed switch that cannot easily be affected by external conditions such as weather, which can impact the mechanical switches. Using a magnetic tamper switch for an access control system housing is novel, and has not previously been used due to the complexity of getting the magnetic mechanism to work as a tamper switch. Advantageously, the magnetic tamper switch is more robust because in prior art systems mechanical tamper switches tend to be the weakest part due to failure of the mechanical parts. Specifically, non-magnetic tamper switches are not weather proof. The non-magnetic switches have small spring levers that, when released, cause a tamper alert. The intricate design using these small levers require accurate alignment; the small levers can become faulty if there is even a slight misalignment, for example when the housing is being secured, or if water damage occurs (for example due to rain), water damage affecting the mechanism that releases the lever to issue the tamper alert. These issues (i.e., weather, water damage, and misalignment) do not affect the magnetic switch in the same way.

Because prior art access control systems required onsite assembly and wiring termination, they were subject to poor workmanship or improper installation. Furthermore, during the testing and commissioning stage at project completion, all three tampers would need to be tested; this would require the housing to be opened, exposing a jumble of wires, which are at risk of being damaged when closing the housing again. These same tests are conducted periodically post project completion to maintain the customers' high security level requirements. The housing described herein avoids these problems.

Embodiments of the housing described herein is designed for the largest of the key modules (e.g., card readers) that are suitable to use. The housing includes one or more adapters used to reduce the space within the body of the housing to house alternate readers. For example, the dimensions of the key interface seat may be about 120 mm×85 mm×30 mm. In one example embodiment, the key interface seat has the following dimensions; 121.9 mm long, 83.75 mm wide and 30.00 mm deep. One or more adapters may be included with the housing to support key modules that are equal to or smaller than this seat area.

By combining engineering requirements of access control within the access controller, risk mitigation is achieved through a reduction in installation time and testing errors.

It will be understood to persons skilled in the art of the invention that many modifications may be made without departing from the spirit and scope of the invention.

1. An access control housing for an access control user interface, the housing comprising:
a key interface seat having a key module connector and a key module receiving frame,
wherein the key module connector comprises a power connection for providing power to a key module, and a data connection for providing key module data to a main controller,
wherein the key module receiving frame is adapted to removably receive a key module selected from a group of different key modules.

2. The access control housing of claim 1, where the different key modules have different sizes, and wherein the key module receiving frame is interchangeable so that the key interface seat is adapted to hold key modules of different sizes.

3. The access control housing of claim 1, where the different key modules have different sizes, and wherein the key module receiving frame is resizable so that the key interface seat is adapted to hold key modules of different sizes.
